(19) United States
(12) Patent Application Publication
(10) Pub. No.: US 2025/0276290 A1
(43) Pub. Date: Sep. 4, 2025

(54) APPARATUS AND METHOD FOR SEPARATION OF METAL-BEARING PHASES USING ELECTRODIALYSIS

(71) Applicant: Uplift Geosystems LLC, Baltimore, MD (US)

(72) Inventors: Daniel Nothaft, Baltimore, MD (US); Devan Solanki, Baltimore, MD (US)

(21) Appl. No.: 19/069,101

(22) Filed: Mar. 3, 2025

Related U.S. Application Data
(60) Provisional application No. 63/560,747, filed on Mar. 3, 2024.

(51) Int. Cl. B01D 61/46; B01D 61/44; B01D 65/02; C22B 1/24; C22B 3/00; C22B 3/10; C22B 3/22; C22B 3/44; C22B 21/00; C22B 23/00; C22B 26/22; C22B 34/32; C22B 47/00

(52) U.S. Cl. CPC B01D 61/463; B01D 61/445; B01D 61/465; B01D 61/466; B01D 65/027; C22B 1/2406; C22B 3/10; C22B 3/22; C22B 3/44; C22B 21/0007; C22B 21/0015; C22B 23/005; C22B 23/0423; C22B 26/22; C22B 34/32; C22B 47/00; B01D 2313/243; B01D 2321/168

(57) ABSTRACT

A process for using acid to leach metals from metal silicate, oxide, or oxide-hydroxide feedstock with subsequent alkalinization of the leach liquor, thereby bringing target metal ions into solution and separating the metals as hydroxides, oxides, or oxide-hydroxides. Electrodialysis is used to recycle acid and base in the process. Configurations of the electrochemical cell and means of combining cells in stacks and in series are provided that enable production of acid at high concentration allowing for decreased reactor volumes for leaching and precipitation and improved solid/liquid separation characteristics of the leached slurry.

### FIELD OF THE INVENTION

This invention relates to acid-leaching processes for separating metals from silicate, oxide, and oxide-hydroxide ores.

### BACKGROUND OF THE INVENTION

In hydrometallurgy, acid leach processes are widely used to extract metal values from silicate, oxide, or oxide-hydroxide ores. In many cases, sulfuric acid is used and is not recycled in the process. Some sulfate may be consumed in a chemical product, such as NiSO₄. However, much of the residual sulfate is coupled to lower value metals and precipitated as, e.g., jarosite (an iron sulfate mineral) or neutralized, commonly by lime or limestone and precipitated as gypsum (a calcium sulfate mineral). These processes produce large quantities of sulfate waste that must be managed and often entail a high carbon footprint due to the use of lime/limestone. In leach processes using hydrochloric acid, it is relatively more common to recycle the acid because HCl is more expensive than H₂SO₄ and because HCl can be more readily thermally recycled than H₂SO₄ due to the relative stability of HCl(g) over a wide range of temperatures.

More recently, electrochemical recycling of acids in silicate leach processes has been proposed, including in the context of extracting alkaline compounds such as Mg(OH)₂ for use in carbon dioxide (or more generally, acid gas) removal. For instance, Rau et al. (1) described an application of electrolysis to recycle acid (or both acid and base) in a silicate leach process that extracts metal hydroxides for acid gas removal (as well as higher value hydroxide co-products of geochemically scarce metals including Ni). Lammers et al. (2) described a similar process.

### SUMMARY OF THE INVENTION

The process described herein uses acid to leach metals from metal silicate, oxide, or oxide-hydroxide feedstock with subsequent alkalinization of the leach liquor, thereby bringing target metal ions into solution and separating the metals as hydroxide, oxide, or oxide-hydroxide precipitates. Electrodialysis is used to recycle acid and base in the process.

In one embodiment of the process, the feedstock subjected to leaching is rich in magnesium silicate minerals such as olivine- and serpentine-group minerals. In such cases, it is demonstrated here that relatively high acid strength (>3 mol H⁺/L, preferably 6 mol H⁺/L) is important in decreasing the leaching of silica into solution. High concentrations of dissolved/colloidal silica and related polymeric forms of silica are deleterious because they can form a gel that inhibits solid/liquid separations (increasing filtration/settling times). Further, silica scale can form, fouling reactor surfaces and other process equipment. Electrodialysis systems are presented that enable generation of acid in a desirably high concentration.

Accordingly, there is provided a device comprising multiple stacks of electrochemical cells, each stack containing 1 to 300 electrochemical cells and preferably 50 to 200 electrochemical cells, each electrochemical cell having repeatable architecture of two or three compartments: a compartment where acid is produced, a compartment where base is produced, and optionally a compartment where a salt solution that is more dilute than the feed solution is produced, wherein each compartment within the repeatable architecture consists of a bipolar membrane (“BPM”) and either a cation exchange membrane (“CEM”) or anion exchange membrane (“AEM”), or a cation exchange membrane (“CEM”) and an anion exchange membrane (“AEM”), and the distance between each membrane is maintained by spacers. An anode compartment bound by an anode (“A”) and a cathode compartment bound by a cathode (“C”) bookend the stack of acid, base, and optional diluate compartments. The anode and cathode are electrically connected to a power supply. The bipolar membranes are positioned such that the anion exchange membrane side of the bipolar membrane faces the anode and the cation exchange membrane side of the bipolar membrane faces the cathode. The anode and cathode chambers may or may not be separated from the repeating architectures by a cation or anion exchange membrane. Each compartment has inlets and outlets that allow fluids to pass through them. Tubing is connected to the inlets and outlets of the compartments as a conduit for fluids. The tubing may be connected to reservoirs such as tanks that contain the fluids before or after they pass through the sections of the device that are subjected to electric fields. Pumps are connected to the tubing to pump fluids through the tubing. In a preferred embodiment, the spacers are constructed or positioned such that the base compartment has a larger volume than the acid compartment.

There is further provided according to the invention, a method of producing concentrated acid from saline solution using stacks of electrodialytic cells, the method comprising the steps:
a. pumping dilute (0.1 to 1 mol/L, preferably 0.4 to 0.6 mol/L) saline solution into the acid compartments of a first stack of cells, concentrated saline solution (>0.5 mol/L acceptable, preferably >1.5 mol/L, but ideally as concentrated as possible limited only by the solubility of the salt and in some cases the solution viscosity) into the base compartments of the first stack of cells, and electrode solution (“ES”) into the anode and cathode compartments of the first stack of cells, wherein the dilute saline solution pumped into the acid compartments is pumped at a lower volumetric flow rate than the rate which the concentrated saline solution is pumped into the base compartments. The residence time for the fluid should be proportionally higher in the acid relative to the base (for example, double the residence time in the acid relative to the base compartments to make a 2:1 concentration ratio acid/base). This can be accomplished using a combination of compartment volume and flow rate differences.
b. Applying an electric potential across the electrodes, preferably 1 V per cell to 3 V per cell at 0.1 per cm² of membrane active area to 3.0 Amps per cm² of membrane active area, and more preferably 1.2 V per cell to 2.0 V per cell at 0.5 per cm² of membrane active area to 1.5 Amps per cm² of membrane active area. The electric potential will drive water disassociation in the bipolar membrane and drive the transport of anions across the anion exchange membrane. This creates acid and base, respectively, in alternating compartments. The acids and bases may be flowed once through, or preferably, passed through the stack multiple times via reservoirs to further acidify and alkalize the acid and base streams, respectively.
c. Circulating the electrode rinse solutions from anode and cathode compartments through the same mixed reservoir. A key property of the system is the avoidance of net production/conversion of reagents at the electrodes. This is accomplished by circulating electrode rinse solutions between the anode and cathode compartments containing redox couples with rapid interconversion kinetics. Examples include hydroquinone/benzoquinone, ferric cyanide/ferrous cyanide, and ferric chloride/ferrous chloride.
d. Pumping the outflow from the acid compartments of the first electrodialysis stack (potentially via a reservoir) into the acid compartments of the second electrodialysis stack. The outflow from the base compartment is the final product of the system and does not have a further use in the system.
e. Pumping the same saline solution that is the input to the base compartments of the first stack into the base compartment of a second stack of cells.
f. Operating the second stack in a similar manner as the first stack, by applying a potential across the electrodes and circulating the electrode solutions. This serves to further concentrate the acid with less stress on the membranes than if a similar level of concentration were sought in a single stack. This translates to more membrane longevity and thus lower membrane replacement costs. A result of the system design and operation is that the molar concentration of OH in the base output is less than the concentration of H⁺ in the acid output.

There is further provided according to the invention a method of extracting metals from ultramafic ore by recycling concentrated acid comprising the steps:
a. milling an ultramafic ore (serpentinite, peridotite, or laterite) with major geochemical components that include some or all of the following: MgO, FeO, Fe₂O₃, SiO₂, NiO, Al₂O₃, Cr₂O₃, MnO, CaO and Co₂O₃. The ore should be milled to <1 mm particle diameter, preferably <150 μm particle diameter.
b. Leaching the milled ore in acid of >3 mol H+/L concentration, preferably 4 mol H+/L to 7 mol H+/L (FIG. 7). Other leaching conditions will depend on the ore, but as an example, 3 hours leaching at 90° C. at atmospheric pressure in a vat with agitation sufficient to maintain particles in suspension may be suitable for many serpentinite or peridotite ores. Suitable acids include HCl, HNO₃, and H₂SO₄. High purity of the acid is not required. For example, 0.5 mol/L of a salt such as NaCl in HCl is acceptable.
c. Separating the solid residue and liquids in the leached slurry, for example by filtration or settling.
d. Adding an aqueous base in stages to the resulting leach liquor to sequentially precipitate various metal oxides, hydroxides, or oxide-hydroxides, separating them according to their pH-dependent solubility, with each stage of precipitation followed by a solid/liquid separation. The molar concentration of OH— in the base is less than the concentration of H+ in the acid used for leaching. Preferably, the concentration of OH— in the base is between 1 mol H+/L and 3 mol H+/L. Suitable bases include NaOH, NH₄OH, and KOH. High purity of the base is not required. For example, 0.5 mol/L of a salt such as NaCl in NaOH is acceptable.
e. Pumping the saline solution resulting from the metals precipitations and solid/liquid separations into the electrodialysis system shown in FIGS. 1-6. Depending on the operation of the plant, there may be streams of saline solution of differing concentration, for example due to filter washing. If such streams exist, add the more dilute saline stream into the acid compartment of the electrodialysis system and more concentrated saline stream into the base compartment of the electrodialysis system (FIGS. 1-6). It may be desirable to mix multiple saline streams to obtain consistent and optimal salt concentrations in the electrodialysis system feed solutions. In addition, conventional monopolar electrodialysis may be used to pre-treat the saline feed solution or solutions to obtain optimal salt concentrations for the bipolar membrane electrodialysis system.
f. Directing the acid output of the electrodialysis system to the leaching vessel and the base output to the metals precipitations vessels (FIG. 7).

### BRIEF DESCRIPTION OF DRAWINGS

FIG. 1 shows a bipolar membrane electrodialyzer according to a three chamber recirculating or repeating single stack embodiment of the invention. Abbreviations: “A”=anode, “C”=cathode, “BPM”=bipolar membrane, “CEM”=cation exchange membrane, “AEM”=anion exchange membrane, “ES”=electrode solution. Electrode solutions can include NaOH, H₂SO₄, combinations thereof, other electrolytes, and/or, preferably, dissolved redox pairs with interconversion kinetics such as hydroquinone/benzoquinone, ferric cyanide/ferrous cyanide, and ferric chloride/ferrous chloride. Commercial systems can have up to 200 cells in a stack. The bipolar membrane consists of a cation exchange membrane laminated to an anion exchange membrane. An electrochemical potential applied across the bipolar membrane drives water dissociation resulting in a pH differential between the acid and base compartments.

FIG. 2 shows a bipolar membrane electrodialyzer according to another three chamber embodiment of the invention.

FIG. 3 shows two bipolar membrane electrodialyzers according to the embodiment of FIG. 2, showing two stacks arranged in series.

FIG. 4 shows a bipolar membrane electrodialyzer according to a two chamber BPM-AEM-BPM embodiment of the invention, in which, according to an optional feature, the more diluted saline chamber is narrower than the more concentrated saline chamber.

FIG. 5 shows a bipolar membrane electrodialyzer according to a two chamber BPM-CEM-BPM embodiment of the invention.

FIG. 6 shows a bipolar membrane electrodialyzer according to a three chamber embodiment of the invention in which the acid and base chambers have different widths.

FIG. 7 is a flowchart for a pH swing process, such as metal leach from silicate using electrolysis to regenerate HCl and NaOH.

FIG. 8 shows leaching of elements during reaction of an example ultramafic rock at 90 C.° and 90% stoichiometric acid:rock ratio. The rock was crushed, ground and passed through a dry 125 μm sieve prior to leaching.

### DETAILED DESCRIPTION OF THE INVENTION

One embodiment of the process entails acid leaching of ultramafic rock, e.g. serpentinite or peridotite. Ultramafic rocks are ideal for carbon dioxide (or other acid gas) removal purposes because they are abundant and have high acid-neutralizing capacity. Specifically, they are relatively rich in Mg and poor in Si. Further, they contain substantial concentrations of geochemically scarce metals such as Ni, Co, Mn, and Cr that could be valuable co-products. In addition, their constituent minerals (serpentine and olivine groups) have relatively fast dissolution kinetics. An example chemical composition of an ultramafic rock dominated by the serpentine-group minerals antigorite and lizardite with minor forsterite, chromite, and magnetite is given in Table 1. The process also can be applied to laterite ores, which are ultramafic rocks that have undergone selective weathering processes resulting in enrichment of valuable metals Ni and Co in the residual rock.

TABLE 1
Chemical composition of an example ultramafic rock.

| Component | Mass % |
|---|---|
| MgO | 32.18 |
| Fe2O3 | 7.39 |
| Cr2O3 | 0.35 |
| CaO | 0.39 |
| Al2O3 | 0.94 |
| NiO | 0.28 |
| MnO | 0.10 |
| Na2O | 0.06 |
| Co2O3 | 0.01 |
| SiO2 | 37.86 |
| Loss on ignition | 12.22 |
| sum | 91.80 |

In principle, there are several leaching approaches that could be applied, including in situ (solution mining), heap leaching, and vat leaching. The method described here is most advantageous for vat leaching because the relatively high concentration at which the acid can be regenerated implies severalfold reduction in the volume of the leaching slurry. This enables economical vat sizes and offers the improved process control and solid-liquid contact that vat leaching can achieve versus other approaches. While batch or continuous processes are possible, continuous processing is preferable at industrial scales to maximize throughput for a given reactor volume.

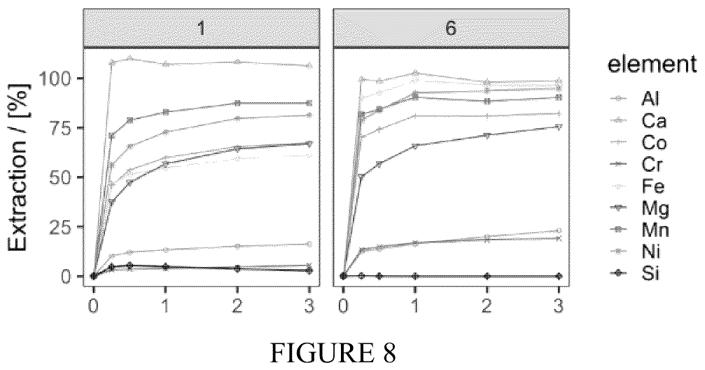

Here, results are presented from laboratory-scale (200 mL liquid volume) batch leaching experiments in heated round-bottom flasks containing PTFE-coated magnetic stir bars. Comminution and heating are known to improve acid leaching kinetics for ultramafic rocks. In leaching experiments, rocks of composition shown in Table 1 were ground via ball mill and dry-sieved to <125 μm, then leached in 1.0 mol/L HCl and 6.0 mol/L HCl, respectively, at 90 C.°. The solids/liquid ratio in this experiment was set to 90% of the calculated stoichiometric amount of HCl necessary to form chloride salts (in solution) with the major metal cations of the rock. A stoichiometric acid:rock ratio less than 100% was chosen to maximize acid conversion to aqueous chloride salts. In the 6.0 mol/L HCl experiment, 76% Mg was extracted after 3 hours, alongside >80% of Fe and the valuable scarce metals Ni, Co, and Mn (FIG. 8, Table 2). In the 1.0 mol/L HCl experiment, metals extractions were similar, although generally somewhat lower.

TABLE 2
Metals extraction and precipitation as [oxide-]hydroxides via pH swing.
Extraction percentages reported here are after 180 minutes
of leaching at at 90 C. ° and 90% stoichiometric acid:rock
ratio (FIG. 8). “b.l.q.” = “below limit of quantitation”.

| | | | % of extract in | | | |
|---|---|---|---|---|---|---|
| | Mass % | % | Precipitate | Precipitate | Final | |
| Element | in rock | extracted | 1 | 2 | filtrate | Sum |
| Mg | 19.41 | 76 | 8 | 85 | b.l.q. | 94 |
| Fe | 5.17 | 97 | 86 | b.l.q. | b.l.q. | 86 |
| Cr | 0.24 | 19 | 89 | 0 | b.l.q. | 89 |
| Ca | 0.28 | 99 | 4 | 37 | 39 | 79 |
| Al | 0.50 | 23 | 79 | 1 | 0 | 80 |
| Ni | 0.22 | 95 | 91 | b.l.q. | b.l.q. | 91 |
| Mn | 0.08 | 90 | 79 | 8 | b.l.q. | 87 |
| Co | 0.01 | 82 | 95 | 6 | 0 | 101 |

Importantly, there were stark differences in the behavior of Si between the 1.0 mol/L HCl and 6.0 mol/L HCl experiments. In the 1.0 mol/L experiments, Si extraction ranged from 3% to 6% over the course of the experiment, whereas in the 6.0 mol/L experiment Si extraction peaked at 0.16% at the 15-minute time point and decreased to below detectable levels by 60 minutes. In terms of Mg:Si mass ratio in the fluid, the 1.0 mol/L experiments hovered around 20, whereas the 6.0 mol/L experiments exceeded 1000. In addition, vacuum filtration times of the residues of 6.0 mol/L experiments were 3 to 4 times faster than the 1.0 mol/L residues, despite the 6.0 mol/L experiments having 6 times greater solid mass (Table 3). In the literature (3), such phenomena have been attributed to hydrated silica gel formation at lower acid strengths, which inhibits filtration. Apparently, this is less of a problem at high ionic strengths and/or low pH. The observation that aqueous Si concentration decreased with time in the 6.0 mol/L experiments suggests that there is at least some reprecipitation of Si, likely in an amorphous and/or opalline form.

The apparently substantial effect of Si leaching on solid/liquid separation efficiency highlights the need to manage Si in the process. Apart from optimizing the leaching conditions to minimize Si leaching, other Si management strategies include adding more acid after the initial leaching and filtration to lower the solubility of Si and precipitate out silica gel or other silica-containing compounds. Additional cleanup of the solution/suspension can also be performed by techniques including ion exchange and ultrafiltration, especially prior to the solution entering the electrochemical cell. These Si removal methods are known and have been proposed as a step in other electrochemical leaching processes (1). However, they can be quite costly. Adding extra acid to the filtrate implies using more electricity to recover Mg(OH)₂. Thus, decreasing the amount of Si that occurs in the leaching step is a major advantage of the methods proposed here.

TABLE 3
Filtrations of leaching slurry performed
on Whatman 5 paper under vacuum.

| HCl concentration [mol/L] | trial | Filtration time [min] |
|---|---|---|
| 1 | 1 | 73 |
| 1 | 2 | 64 |
| 6 | 1 | 19 |
| 6 | 2 | 18 |

The filtered leachate was brought to alkaline pH through addition of 1.0 mol/L NaOH dropwise via syringe, with filtration of precipitates in stages (Table 2). The concentrations of the precipitates were determined by re-dissolving the precipitates in 10% w/w HNO3 at room temperature for 130 minutes, then passing an aliquot of the homogenized solution through a 0.45 μm syringe tip filter prior to dilution and analysis via inductively-coupled plasma atomic emission spectroscopy. Due to differential solubility of metals at varying pH, and consistent with known metallurgical processes to produce metal hydroxide concentrates, it was found that metals were concentrated into different precipitate fractions (Table 2). In this experiment, precipitates were collected at pH 9.42 and then 12.72. Most of the Fe, Ni, and other transition metals were concentrated in the first precipitate, whereas Mg was effectively concentrated in the second precipitate.

While the results in FIG. 8 and Table 2 serve as a proof of concept of the possibility of producing purified metals or concentrates through this process, more elaborate metals separations techniques could be applied at scale. While only two precipitates were collected in the demonstrative experiment described here, a simple modification to impart better separations of metals would be to include additional filtrations at finer increments of pH. There are other metals separation approaches leveraging more than just pH that could be beneficial at industrial scale, as described below.

An important first step after leaching and solid/liquid separation is Fe removal due to the chemical similarities of Fe and Ni and the higher abundance of Fe (Table 1). One of the more direct Fe removal methods is through goethite (FeO*OH) precipitation through a process that requires tight control of pH and fO₂, but that efficiently decreases Fe concentrations in the filtrate to <1 g/L (4). The pH could be controlled by addition of either a soluble alkali hydroxide (e.g., NaOH), or an alkaline earth metal hydroxide solid/slurry (e.g., Mg(OH)₂) recycled from the output of the process, or another base, such as NH₄OH. Serpentinites have advantages over unaltered peridotites in terms of Fe removal because a substantial portion of the Fe²⁺ originally present in primary silicate minerals has been oxidized by water and transferred to magnetite (Fe₃O₄) through natural geologic processes, and this magnetite can be readily magnetically separated prior to leaching. Magnetite abundance can, however, be quite variable between different deposits due to differences in temperature and water:rock ratio during serpentinization (5, 6). Nonetheless, a commercial demonstration plant that uses HCl leaching of chrysotile tailings to produce metallic Mg reports that the yield of Fe removal through magnetic separation can exceed 90% (7). Magnetite is also a suitable Fe ore and its removal prior to leaching conserves HCl. In addition, chromite may be separated before or after leaching by gravity separation methods. Separation of opaque minerals in the stirred leaching solution has been observed visually in the laboratory trials described here.

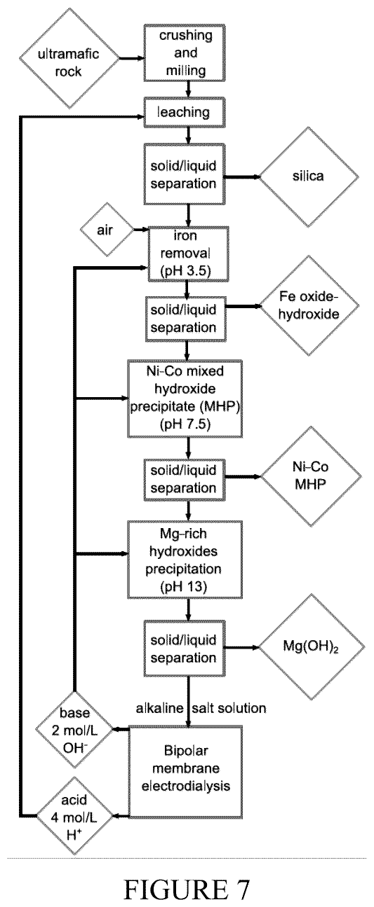

After Fe removal, Ni²⁺ must be separated from the MgCl₂ solution. One way to do this would be to precipitate it along with Co in a mixed hydroxide precipitate through sequential pH elevation (FIG. 7).

Following separation of Ni, Co, and Mn, the remaining solution will contain mostly Mg, with some Ca and other minor solutes. The pH of this solution can be increased via addition of base, such as NaOH to precipitate Mg(OH)₂ and Ca(OH)₂, if desired.

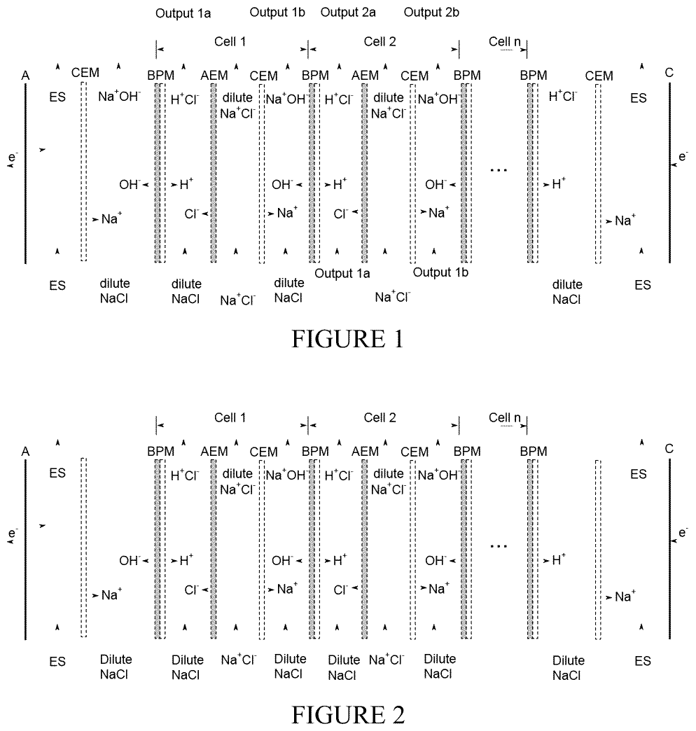

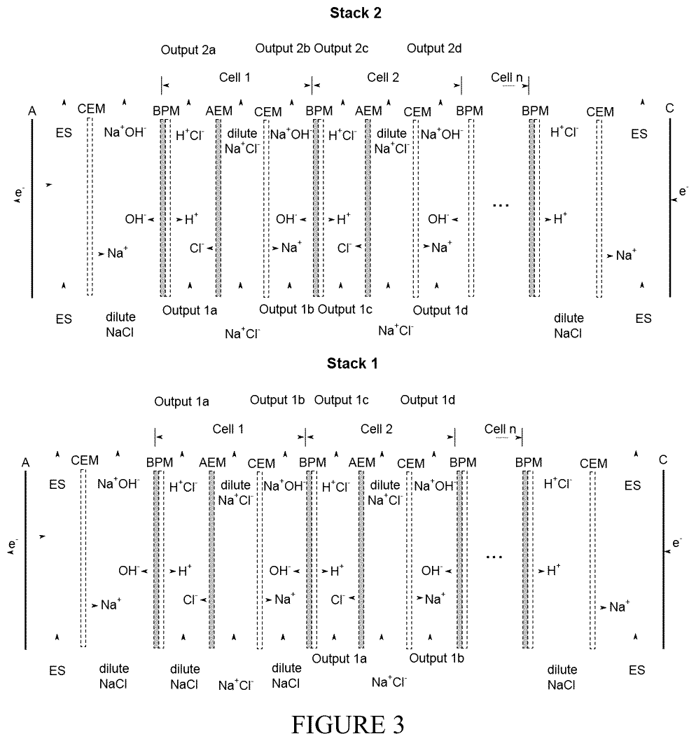

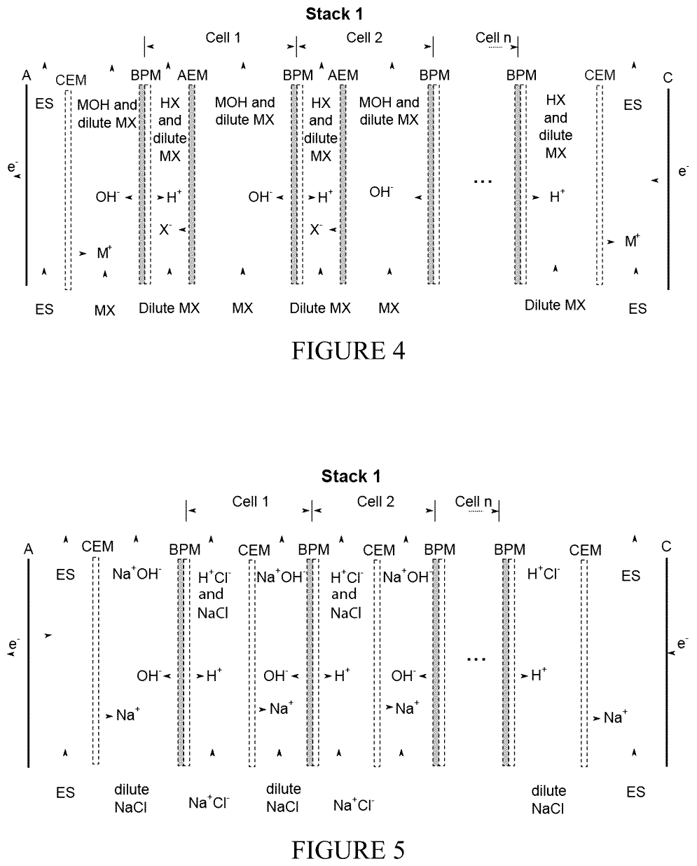

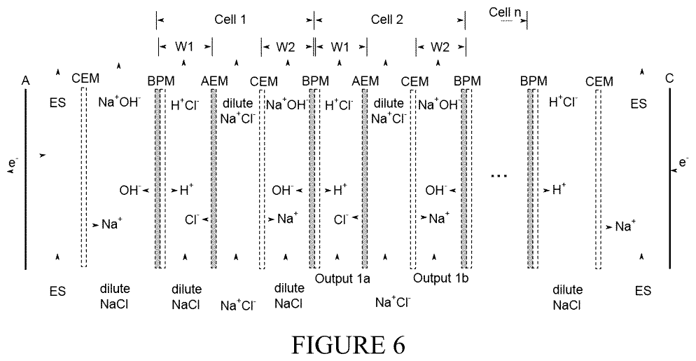

The predominantly NaCl(aq) solution after the Mg(OH)₂/Ca(OH)₂ precipitation and filtration is then electrodialyzed to recover acid and base in the process. The electrochemical cell design and methods of combining cells proposed here (FIGS. 1-6) allow for enrichment of the acid concentration beyond what is achieved in typical industrial practice. Since having high acid concentration is more important than having high base concentration, the acid compartment volumes and flow rates can be lower than the base compartment to optimize for this. Further, since our process is tolerant of saline contamination in the acid and base streams, it is possible to optimize the systems' operation (e.g. flow rates, applied potentials) to yield higher concentration acid at the expense of higher purity acid, which is in contrast to most industrial processes using bipolar membrane electrodialysis. Stringing together bipolar membrane electrodialyzers in series is another method in which to sequentially elevate the acid concentration, while not rupturing membranes due to osmotic pressure differentials. In general, bipolar membrane electrodialysis can achieve lower-energy demand per mole of acid generated relative to electrolysis systems by decreasing the relative amount of energy-intensive redox reactions such as oxygen and chlorine evolution relative to the amount of acid or base produced. However, some oxygen and chlorine gas may be produced at the anode. In some cases, this may be desirable if strong oxidizing compounds such as these are useful for controlling oxidation-reduction potential in other parts of the process, for example to control redox-dependent solubilities of certain metal species.

### REFERENCES CITED

1. G. H. Rau, S. Tahmasebi, C. M. H. Brereton, A. V. Mezei, M. J. Kelland, ELECTROCHEMICAL SYSTEM, APPARATUS AND METHOD TO GENERATE METAL HYDROXIDE IN THE PRESENCE OF METAL SILICATES (2021).
2. L. N. Lammers, Electrolytic sulfuric acid production for gigaton-scale direct air mineral carbon sequestration, 1-20.
3. E. C. Houston, Magnesium from Olivine. Trans. Am. Inst. Min. Metall. Eng. 173, 351-364 (1947).
4. P. T. Davey, T. R. Scott, Removal of iron from leach liquors by the “Goethite” process. Hydrometallurgy. 2, 25-33 (1976).
5. E. T. Ellison et al., Low-Temperature Hydrogen Formation During Aqueous Alteration of Serpentinized Peridotite in the Samail Ophiolite. J. Geophys. Res. Solid Earth. 126, 1-25.
6. T. M. McCollom, W. Bach, Thermodynamic constraints on hydrogen generation during serpentinization of ultramafic rocks. Geochim. Cosmochim. Acta. 73, 856-875 (2009).
7. J. Fournier, A. Luo et al., Eds. (Springer International Publishing, Cham, 2021), pp. 3-11.

1. A device comprising
a. multiple stacks of electrochemical cells, each stack containing 1 to 300 electrochemical cells, each electrochemical cell having repeatable architecture of two or three compartments including at least a compartment where acid is produced, a compartment where base is produced,
b. wherein each compartment within the repeatable architecture consists of i) a bipolar membrane (“BPM”) having an anode exchange side and a cation exchange membrane side and either a cation exchange membrane (“CEM”) or an anion exchange membrane (“AEM”), or ii) a cation exchange membrane (“CEM”) and an anion exchange membrane (“AEM”), and wherein the distance between each membrane is maintained by spacers.
c. Wherein each stack of electrochemical cells is bookended by an anode compartment and a cathode compartment, the anode compartment bound on the inside by an internal cation exchange membrane (“CEM”) and bound on the outside by an anode (“A”), the cathode compartment bound on the inside by a n internal cation exchange membrane (“CEM”) and bound on the outside by a cathode (“C”), the anode and cathode electrically connected to a power supply.
d. wherein each bipolar membrane is positioned such that the anion exchange membrane side of the bipolar membrane (“BPM”) faces the anode and wherein the cation exchange membrane side of the bipolar membrane (“BPM”) faces the cathode.
e. wherein each compartment comprised an inlet and an outlet configured to allow fluid to pass into and out of each said compartment.
said device further comprising
f. tubing connected to the inlets and outlets of the compartments configure to convey fluid into and out of the compartments,
g. pumps are connected to the tubing to pump fluids through the tubing.

2. The device of claim 1, wherein each said stack contains 50 to 200 electrochemical cells.

3. The device of claim 1, further comprising a compartment where a salt solution that is more dilute than the dilute saline solution is produced.

4. The device of claim 1, wherein the anode and cathode chambers are separated from the repeating architectures by a cation or anion exchange membrane.

5. The device of claim 1, wherein the anode and cathode chambers are not separated from the repeating architectures by a cation or anion exchange membrane.

6. The device of claim 1, wherein the tubing is connected to reservoirs such as tanks that contain the fluids before or after they pass through the sections of the device that are subjected to electric fields.

7. The device of claim 1, wherein the spacers are constructed or positioned such that the base compartment has a larger volume than the acid compartment.

8. The device of claim 1, comprising BPM-AEM-BPM two-compartment cells.

9. The device of claim 1, comprising BPM-CEM-BPM two-compartment cells.

10. The device of claim 1, comprising BPM-AEM-CEM-BPM three compartment cells.

11. A method of producing concentrated acid from the saline solution using the device of claim 1, the method comprising the steps:
a. pumping dilute saline solution having a concentration of 0.1 to 1 mol/L into the acid compartments of a first stack of cells at a first volumetric rate,
b. pumping concentrated saline solution having a concentration of >0.5 mol/L into the base compartments of the first stack of cells at a second volumetric rate that is higher than said first volumetric rate,
c. pumping electrode solution (“ES”) into the anode and cathode compartments of the first stack of cells,
i. wherein the residence time of the dilute saline solution in the acid compartments proportionally higher than the residence time of the concentrated saline solution in the base compartments.
d. Applying an electric potential across the electrodes sufficient to drive water disassociation in the bipolar membranes and drive the transport of anions across the anion exchange membrane to create acid and base, respectively, in alternating compartments.
e. Circulating the electrode rinse solutions from anode and cathode compartments through the same mixed reservoir. A key property of the system is the avoidance of net production/conversion of reagents at the electrodes. This is accomplished by circulating electrode rinse solutions between the anode and cathode compartments containing redox couples with rapid interconversion kinetics. Examples include hydroquinone/benzoquinone, ferric cyanide/ferrous cyanide, and ferric chloride/ferrous chloride.
f. Pumping the outflow from the acid compartments of the first electrodialysis stack into the acid compartments of the second electrodialysis stack.
g. Pumping the same saline solution that is the input to the base compartments of the first stack into the base compartment of a second stack of cells.
h. Operating the second stack in a similar manner as the first stack, by applying a potential across the electrodes and circulating the electrode
i. Wherein the molar concentration of OH— in the base output is less than the concentration of H+ in the acid output.

12. The method of claim 11, wherein the dilute saline solution has a concentration of 0.4 to 0.6 mol/L.

13. The method of claim 11, wherein the concentrated saline solution has a concentration of >1.5 mol/L.

14. The method of claim 11 wherein the residence time in the acid compartment is double the residence time of the fluid in the base compartment to generate a 2:1 concentration ratio of acid/base).

15. The method of claim 11, wherein the difference in residence time is accomplished using a combination of compartment volume and flow rate differences.

16. The method of claim 11 comprising applying an electric potential across the electrodes at 1 V per cell to 3 V per cell at 0.1 Amps per cm² of membrane active area to 3.0 Amps per cm² of membrane active area.

17. The method of claim 11 comprising applying an electric potential across the electrodes at 1.2 V per cell to 2.0 V per cell at 0.5 Amps per cm² of membrane active area to 1.5 Amps per cm² of membrane active area.

18. The method of claim 11, wherein the acids and bases are passed through the stack multiple times to further acidify and alkalize the acid and base streams, respectively.

19. The method of claim 11, wherein the outflow from the acid compartments of the first electrodialysis stack is pumped into the acid compartments of the second electrodialysis stack via a reservoir.

20. The method of claim 11, wherein the outflow from the base compartment is the final product of the system and does not have a further use in the system.

21. A method of extracting metals from ultramafic ore by recycling concentrated acid comprising the steps:
a. milling an ultramafic ore to <1 mm particle diameter,
b. Leaching the milled ore in acid of >3 mol H+/L concentration at conditions sufficient to maintain particles in suspension,
c. Separating the solid residue and liquids in the leached slurry,
d. Adding an aqueous base in stages to the resulting leach liquor to sequentially precipitate metal oxides, hydroxides, and/or oxide-hydroxides, separating them according to their pH-dependent solubility, each stage of precipitation followed by a solid/liquid separation,
e. Pumping the saline solution resulting from the metals precipitations and solid/liquid separations into the device of claim 1.
f. Directing the acid output from step e to a leaching vessel and the base output to metal precipitations vessels.

22. The method of claim 21, wherein the ultramafic ore is serpentinite, peridotite, or laterite.

23. The method of claim 21, wherein the ultramafic ore contains one or more of MgO, FeO, Fe₂O₃, SiO₂, NiO, Al₂O₃, Cr₂O₃, MnO, CaO and Co₂O₃.

24. The method of claim 21, wherein the ultramafic ore is milled to <150 μm particle diameter.

25. The method of claim 21, wherein the milled ore is leached in acid having a concentration of 4 mol H+/L to 7 mol H+/L.

26. The method of claim 21, wherein the leaching acid is HCl, HNO₃, or H₂SO₄.

27. The method of claim 21, wherein the molar concentration of OH— in the base is less than the concentration of H+ in the acid used for leaching.

28. The method of claim 21, wherein the concentration of OH— in the base is between 1 mol H+/L and 3 mol H+/L.

29. The method of claim 21, wherein the base used for leaching is one of NaOH, NH₄OH, and KOH.
